(19) United States
(12) Patent Application Publication
(10) Pub. No.: US 2026/0104727 A1
(43) Pub. Date: Apr. 16, 2026

(54) SEMICONDUCTOR CIRCUIT AND DETERMINATION METHOD

(71) Applicants: Kabushiki Kaisha Toshiba, Tokyo (JP); Toshiba Electronic Devices & Storage Corporation, Tokyo (JP)

(72) Inventor: Munenori SAKAI, Kawasaki Kanagawa (JP)

(21) Appl. No.: 19/067,512

(22) Filed: Feb. 28, 2025

(30) Foreign Application Priority Data
Oct. 10, 2024 (JP) 2024-178321

(51) Int. Cl. G05F 3/30

(52) U.S. Cl. CPC G05F 3/30

(57) ABSTRACT

A semiconductor circuit includes a bandgap reference circuit unit and a detection circuit unit. The bandgap reference circuit unit includes a control transistor and a control circuit unit configured to apply a drive voltage to the control transistor. The control transistor includes a first terminal connected to a wiring to which a first power supply voltage is applied, a second terminal connected to a reference voltage wiring, and a drive terminal. The control transistor is in an ON state when a voltage of the drive terminal relative to a voltage of the first terminal is a negative value and is equal to or lower than a threshold value. The detection circuit unit has a first determination circuit unit that outputs a signal indicating whether or not the reference voltage is stable at a first predetermined value on the basis of the drive voltage output from the control circuit unit.

### CROSS-REFERENCE TO RELATED APPLICATION

This application is based upon and claims the benefit of priority from Japanese Patent Application No. 2024-178321, filed Oct. 10, 2024; the entire contents of which are incorporated herein by reference.

### FIELD

Embodiments described herein relate generally to a semiconductor circuit and a determination method.

### BACKGROUND

A bandgap reference (BGR) circuit that generates a reference voltage is known. In the bandgap reference circuit, there is a problem in that the reference voltage generated becomes unstable when a value of a power supply voltage applied to the bandgap reference circuit is low. Therefore, when the reference voltage generated by the bandgap reference circuit is used, it is necessary to take a measure to curb an erroneous output occurring in a region in which the reference voltage becomes unstable. In the past, for example, measures were taken to prevent a determination using the reference voltage in a voltage region in which the reference voltage becomes unstable by identifying in advance the voltage region in which the reference voltage becomes unstable and setting a threshold value based on a value of the identified region. In this case, however, since it is necessary to identify and set the threshold value in advance, there is a problem in that a circuit design is time-consuming.

### BRIEF DESCRIPTION OF THE DRAWINGS

FIG. 1 is a circuit diagram showing a semiconductor circuit according to a first embodiment.

FIG. 2 is a diagram showing an example of changes in a BGR power supply voltage and a reference voltage when a circuit power supply voltage according to the first embodiment is changed.

FIG. 3 is a diagram showing an example of changes in a BGR power supply voltage, a drive voltage, a first voltage, a second voltage, a third voltage, a fourth voltage, a fifth voltage, and an output voltage when a circuit power supply voltage according to the first embodiment is changed.

FIG. 4 is a circuit diagram showing a semiconductor circuit according to a second embodiment.

FIG. 5 is a circuit diagram showing a semiconductor circuit according to a third embodiment.

### DETAILED DESCRIPTION

A semiconductor circuit of the embodiment includes a bandgap reference circuit unit that generates a reference voltage, and a detection circuit unit. The bandgap reference circuit unit includes a control transistor disposed between a wiring to which a first power supply voltage is applied and a reference voltage wiring to which the reference voltage is applied, and a control circuit unit that applies a drive voltage to the control transistor so that the reference voltage becomes a first predetermined value. The control transistor has a first terminal connected to the wiring to which the first power supply voltage is applied, a second terminal connected to the reference voltage wiring, and a drive terminal to which the drive voltage is applied. The control transistor is in an ON state when a voltage of the drive terminal with respect to a voltage of the first terminal has a negative value and is equal to or lower than a threshold value. The detection circuit unit includes a first determination circuit unit that outputs a signal indicating whether or not the reference voltage is stable at the first predetermined value on the basis of the drive voltage output from the control circuit unit.

Hereinafter, semiconductor circuits and determination methods according to embodiments will be described with reference to the drawings.

### (First Embodiment)

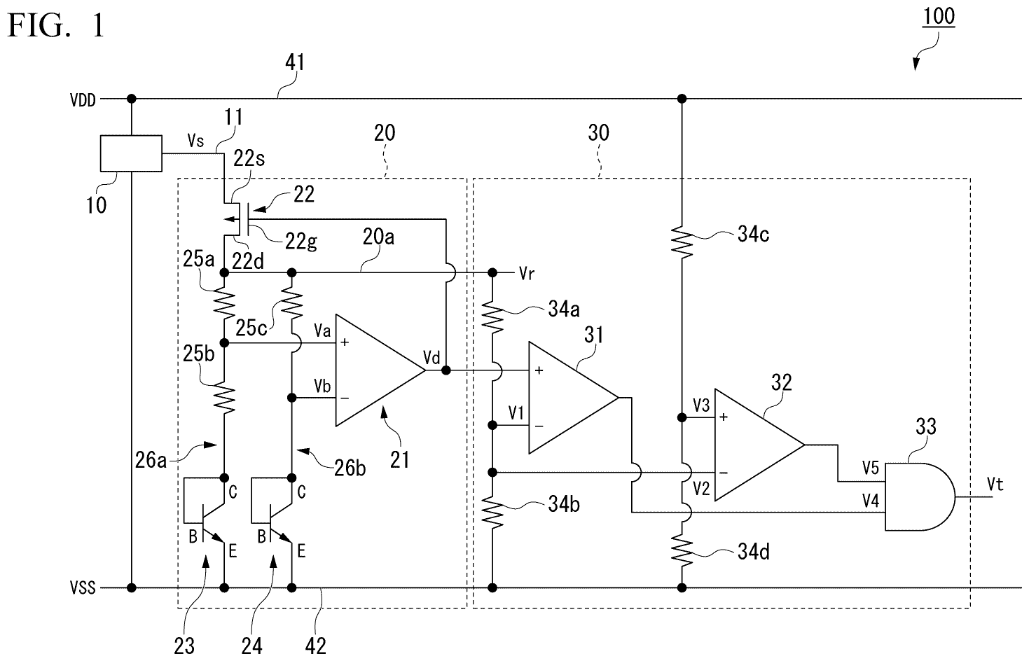

FIG. 1 is a circuit diagram showing a semiconductor circuit 100 according to a first embodiment. As shown in FIG. 1, the semiconductor circuit 100 includes a power supply unit 10, a bandgap reference circuit unit 20, and a detection circuit unit 30. The power supply unit 10 applies a BGR power supply voltage Vs to the bandgap reference circuit unit 20. In the first embodiment, the power supply unit 10 is a regulator circuit that generates the BGR power supply voltage Vs using a circuit power supply voltage VDD applied to the semiconductor circuit 100. That is, in the first embodiment, the BGR power supply voltage Vs is a voltage generated on the basis of the circuit power supply voltage VDD. The power supply unit 10 outputs the BGR power supply voltage Vs to a wiring 11. The wiring 11 is a wiring to which the BGR power supply voltage Vs is applied. In the first embodiment, the BGR power supply voltage Vs corresponds to a “first power supply voltage.” The circuit power supply voltage VDD is a voltage based on a reference potential VSS. In the first embodiment, the circuit power supply voltage VDD corresponds to a “second power supply voltage. ” The reference potential VSS is a potential that serves as a reference in the semiconductor circuit 100. The reference potential VSS is not particularly limited as long as it is a potential that serves as a reference in the semiconductor circuit 100. The power supply unit 10 is disposed between a power supply voltage wiring 41 to which the circuit power supply voltage VDD is applied and a ground 42 that serves as the reference potential VSS. The power supply unit 10 may be a circuit that short-circuits the power supply voltage wiring 41 and the wiring 11. In this case, the BGR power supply voltage Vs becomes equal to the circuit power supply voltage VDD.

In the circuits disclosed herein, “a separate element is disposed between one element and another element” means that the separate element is provided on a circuit from one of the one element and the other element to the other.

The bandgap reference circuit unit 20 generates a reference voltage Vr. The bandgap reference circuit unit 20 includes a reference voltage wiring 20a, a control circuit unit 21, a control transistor 22, bipolar transistors 23 and 24, and resistor elements 25a, 25b, and 25c. The reference voltage wiring 20a is a wiring to which the reference voltage Vr is applied.

The control transistor 22 is disposed between the wiring 11 to which the BGR power supply voltage Vs is applied and the reference voltage wiring 20a to which the reference voltage Vr is applied. In the first embodiment, the control transistor 22 is a P-channel type field-effect transistor (FET). More specifically, the control transistor 22 is a P-channel type metal-oxide-semiconductor field-effect transistor (MOSFET). The control transistor 22 has a source terminal 22s, a drain terminal 22d, and a gate terminal 22g. The source terminal 22s is connected to the wiring 11. The drain terminal 22d is connected to the reference voltage wiring 20a. A drive voltage Vd is applied from the control circuit unit 21 to the gate terminal 22g. In the first embodiment, the source terminal 22s corresponds to the “first terminal,” the drain terminal 22d corresponds to the “second terminal,” and the gate terminal 22g corresponds to the “drive terminal.” The control transistor 22 is in an ON state when a voltage of the gate terminal 22g relative to a voltage of the source terminal 22s, that is, a gate-source voltage, has a negative value and is equal to or lower than a threshold value.

In the first embodiment, the bipolar transistors 23 and 24 are NPN-type bipolar transistors. In each of the bipolar transistors 23 and 24, a collector terminal C and a base terminal B are connected to each other. That is, each of the bipolar transistors 23 and 24 is diode-connected.

The resistor element 25a, the resistor element 25b, and the bipolar transistor 23 are connected in series and disposed between the reference voltage wiring 20a and the ground 42. One end of the resistor element 25a is connected to the reference voltage wiring 20a. The other end of the resistor element 25a is connected to one end of the resistor element 25b. The other end of the resistor element 25b is connected to the collector terminal C of the bipolar transistor 23. An emitter terminal E of the bipolar transistor 23 is connected to the ground 42. A first current path portion 26a is formed by connecting the resistor element 25a, the resistor element 25b and the bipolar transistor 23 in series. The first current path portion 26a connects the reference voltage wiring 20a and the ground 42. Resistance values of the resistor elements 25a and 25b are not particularly limited.

The resistor element 25c and the bipolar transistor 24 are connected in series and disposed between the reference voltage wiring 20a and the ground 42. One end of the resistor element 25c is connected to the reference voltage wiring 20a. The other end of the resistor element 25c is connected to the collector terminal C of the bipolar transistor 24. An emitter terminal E of the bipolar transistor 24 is connected to the ground 42. A second current path portion 26b is formed by connecting the resistor element 25c and the bipolar transistor 24 in series. The second current path portion 26b connects the reference voltage wiring 20a and the ground 42. The first current path portion 26a and the second current path portion 26b are disposed in parallel with each other between the reference voltage wiring 20a and the ground 42. A resistance value of the resistor element 25c is not particularly limited.

The control circuit unit 21 applies the drive voltage Vd to the control transistor 22 so that the reference voltage Vr becomes a first predetermined value Ve. A voltage Va at a portion of the first current path portion 26a between the resistor element 25a and the resistor element 25b, and a voltage Vb at a portion of the second current path portion 26b between the resistor element 25c and the bipolar transistor 24 are input to the control circuit unit 21. The control circuit unit 21 adjusts a value of the drive voltage Vd so that the voltage Va and the voltage Vb have the same value. In the first embodiment, the bandgap reference circuit unit 20 is configured so that when the voltage Va and the voltage Vb have the same value, the value of the generated reference voltage Vr becomes the first predetermined value Ve. The first predetermined value Ve is, for example, about 1.2 V.

The phrase “the control circuit unit 21 applies the drive voltage Vd to the control transistor 22 so that the reference voltage Vr becomes the first predetermined value Ve” may mean that the control circuit unit 21 controls the value of the drive voltage Vd with the first predetermined value Ve as a target value of the reference voltage Vr, and may mean that the reference voltage Vr may not become the first predetermined value Ve as a result of applying the drive voltage Vd to the control transistor 22. For example, as will be described below, when the BGR power supply voltage Vs is lower than a certain value, the reference voltage Vr will not become the first predetermined value Ve no matter how the drive voltage Vd is adjusted. In this case, the control circuit unit 21 controls the drive voltage Vd so that the reference voltage Vr becomes a value close to the first predetermined value Ve within a range that can be adjusted by the drive voltage Vd.

The detection circuit unit 30 is capable of detecting that the circuit power supply voltage VDD has become lower than a second predetermined value VDDa on the basis of the reference voltage Vr. The second predetermined value VDDa is a value that is appropriately set on the basis of a value of a voltage value required for a circuit that uses the circuit power supply voltage VDD, and is not particularly limited. The detection circuit unit 30 is connected to the bandgap reference circuit unit 20. The detection circuit unit 30 includes a first determination circuit unit 31, a second determination circuit unit 32, a third determination circuit unit 33, and resistor elements 34a, 34b, 34c, and 34d.

The resistor elements 34a and 34b are connected in series and disposed between the reference voltage wiring 20a and ground 42. One end of the resistor element 34a is connected to the reference voltage wiring 20a. The other end of the resistor element 34a is connected to one end of the resistor element 34b. The other end of the resistor element 34b is connected to the ground 42. A resistance value of each of the resistor elements 34a and 34b is appropriately set on the basis of, for example, values of a first voltage V1 and a second voltage V2 which will be described below.

The resistor element 34c and the resistor element 34d are connected in series and disposed between the power supply voltage wiring 41 and the ground 42. One end of the resistor element 34c is connected to the power supply voltage wiring 41. The other end of the resistor element 34c is connected to one end of the resistor element 34d. The other end of the resistor element 34d is connected to the ground 42. A resistance value of each of the resistor elements 34c and 34d is appropriately set on the basis of, for example, a value of a third voltage V3 which will be described below.

The drive voltage Vd output from the control circuit unit 21 and the first voltage V1 are input to the first determination circuit unit 31. The first voltage V1 is a voltage based on the reference voltage Vr. In the first embodiment, the first voltage V1 is a voltage obtained by dividing the reference voltage Vr by the resistor elements 34a and 34b, that is, a resistance-divided voltage of the reference voltage Vr. The first voltage V1 is a voltage between the resistor element 34a and the resistor element 34b. A value of the first voltage V1 is determined by a value of the reference voltage Vr and a ratio between the resistor element 34a and the resistor element 34b.

The first determination circuit unit 31 is a comparator that compares the drive voltage Vd with the first voltage V1 and outputs a fourth voltage V4. When the drive voltage Vd is higher than the first voltage V1, the first determination circuit unit 31 sets the output fourth voltage V4 to a high level. When the drive voltage Vd is equal to or lower than the first voltage V1, the first determination circuit unit 31 sets the output fourth voltage V4 to a low level.

The second voltage V2 and the third voltage V3 are input to the second determination circuit unit 32. The second voltage V2 is a voltage based on the reference voltage Vr. In the first embodiment, the second voltage V2 is a voltage obtained by dividing the reference voltage Vr by the resistor elements 34a and 34b, that is, a resistance-divided voltage of the reference voltage Vr. The second voltage V2 is a voltage between the resistor element 34a and the resistor element 34b. A value of the second voltage V2 is determined by the value of the reference voltage Vr and the ratio between the resistor element 34a and the resistor element 34b. In the first embodiment, the value of the second voltage V2 is the same as the value of the first voltage V1. The third voltage V3 is a voltage based on the circuit power supply voltage VDD. In the first embodiment, the third voltage V3 is a voltage obtained by dividing the circuit power supply voltage VDD by the resistor elements 34c and 34d, that is, a resistance-divided voltage of the circuit power supply voltage VDD. The third voltage V3 is a voltage between the resistor element 34c and the resistor element 34d. A value of the third voltage V3 is determined by a value of the circuit power supply voltage VDD and a ratio between the resistor element 34c and the resistor element 34d.

The second determination circuit unit 32 is a comparator that compares the second voltage V2 and the third voltage V3 and outputs a fifth voltage V5. When the third voltage V3 is higher than the second voltage V2, the second determination circuit unit 32 sets the output fifth voltage V5 to a high level. When the third voltage V3 is equal to or lower than the second voltage V2, the second determination circuit unit 32 sets the output fifth voltage V5 to a low level.

At least one other resistor element may be disposed between the resistor element 34a and a wiring portion that is connected to the first determination circuit unit 31 and has the first voltage V1, between the wiring portion that is connected to the first determination circuit unit 31 and has the first voltage V1 and a wiring portion that is connected to the second determination circuit unit 32 and has the second voltage V2, and between the wiring portion that is connected to the second determination circuit unit 32 and has the second voltage V2 and the resistor element 34b.

A signal output from the first determination circuit unit 31, that is, the fourth voltage V4, and a signal output from the second determination circuit unit 32, that is, the fifth voltage V5 may be input to the third determination circuit unit 33. The third determination circuit unit 33 outputs an output voltage Vt on the basis of the fourth voltage V4 and the fifth voltage V5. The output voltage Vt is an output signal of the detection circuit unit 30. In the first embodiment, the third determination circuit unit 33 is an AND circuit. When both the fourth voltage V4 and the fifth voltage V5 are high, the third determination circuit unit 33 sets a level of the output voltage Vt to a high level. When at least one of the fourth voltage V4 and the fifth voltage V5 is low, the third determination circuit unit 33 sets a level of the output voltage Vt to a low level. In other words, when the level of the fourth voltage V4 is low and when the level of the fifth voltage V5 is low, the third determination circuit unit 33 sets the level of the output voltage Vt to a low level.

When the level of the output voltage Vt is high, the circuit power supply voltage VDD is equal to or higher than the second predetermined value VDDa. In other words, when the level of the output voltage Vt is high, the output voltage Vt is a signal indicating that the circuit power supply voltage VDD is equal to or higher than the second predetermined value VDDa. As described above, the level of the output voltage Vt becomes high when the level of the fourth voltage V4 and the level of the fifth voltage V5 are both high. In the first embodiment, a predetermined condition is satisfied when the level of the fourth voltage V4 and the level of the fifth voltage V5 are both high. When the predetermined condition is satisfied, the third determination circuit unit 33 outputs an output voltage Vt of which a level is high as a signal indicating that the circuit power supply voltage VDD is equal to or higher than the second predetermined value VDDa. When the level of the output voltage Vt is low, the circuit power supply voltage VDD is lower than the second predetermined value VDDa. In other words, when the level of the output voltage Vt is low, the output voltage Vt is a signal indicating that the circuit power supply voltage VDD is lower than the second predetermined value VDDa. When the above-described predetermined condition is not satisfied, the third determination circuit unit 33 outputs an output voltage Vt of which a level is low as a signal indicating that the circuit power supply voltage VDD is lower than the second predetermined value VDDa.

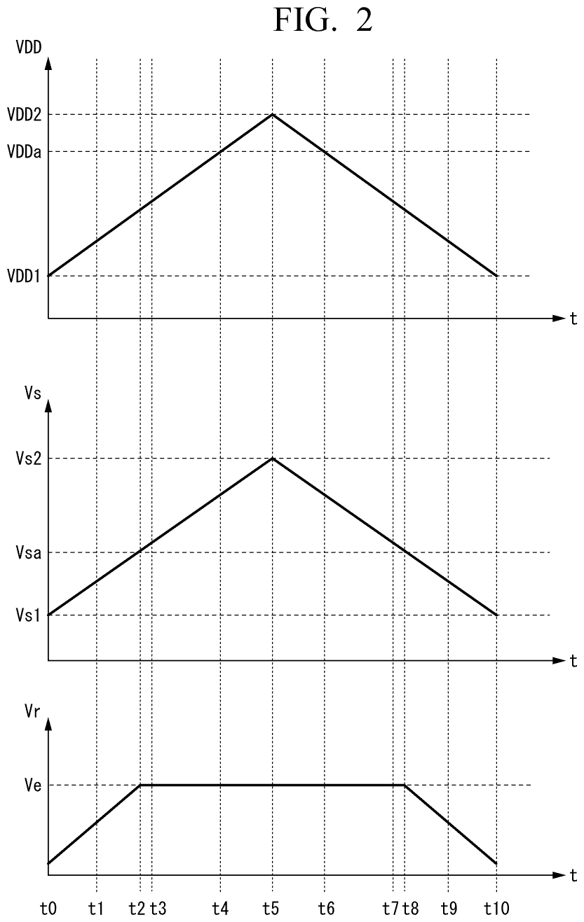

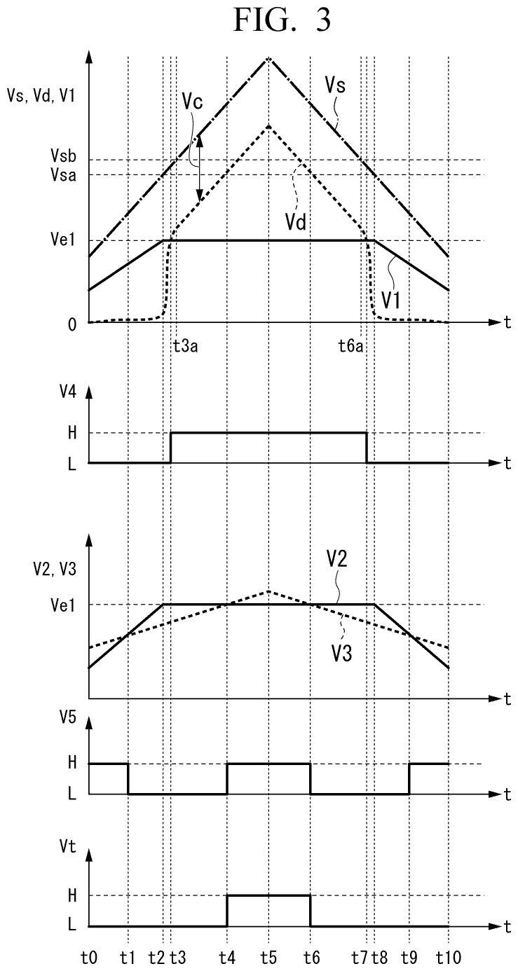

FIG. 2 is a diagram showing an example of changes in the BGR power supply voltage Vs and the reference voltage Vr when the circuit power supply voltage VDD is changed. An upper graph in FIG. 2 is a graph showing a change in the circuit power supply voltage VDD. A center graph in FIG. 2 is a graph showing a change in the BGR power supply voltage Vs. A bottom graph in FIG. 2 is a graph showing a change in the reference voltage Vr. FIG. 3 is a diagram showing an example of changes in the BGR power supply voltage Vs, the drive voltage Vd, the first voltage V1, the second voltage V2, the third voltage V3, the fourth voltage V4, the fifth voltage V5, and the output voltage Vt when the circuit power supply voltage VDD is changed. A top graph in FIG. 3 is a graph showing changes in the BGR power supply voltage Vs, the drive voltage Vd, and the first voltage V1. The second graph from the top in FIG. 3 is a graph showing a change in the fourth voltage V4. The third graph from the top in FIG. 3 is a graph showing changes in the second voltage V2 and the third voltage V3. The second graph from the bottom in FIG. 3 is a graph showing a change in the fifth voltage V5. The bottom graph in FIG. 3 is a graph showing a change in output voltage Vt. In each of the graphs in FIG. 2 and FIG. 3, a horizontal axis represents a time t.

The examples of FIGS. 2 and 3 show changes in each of the voltages when the circuit power supply voltage VDD is changed from a time t0 to a time t10. As shown in FIG. 2, the circuit power supply voltage VDD increases linearly from a value VDD1 to a value VDD2 between the time t0 and the time t5, and decreases linearly from the value VDD2 to the value VDD1 between the time t5 and the time t10. The value VDD1 is a value lower than the second predetermined value VDDa. The value VDD2 is a value higher than the second predetermined value VDDa. As shown in FIG. 3, the third voltage V3 is a resistance-divided voltage of the circuit power supply voltage VDD, and thus varies in the same manner as the circuit power supply voltage VDD between the time t0 and the time t10, although a magnitude thereof is different.

As shown in FIG. 2, when the circuit power supply voltage VDD changes, the BGR power supply voltage Vs based on the circuit power supply voltage VDD also changes in the same manner as the change of the circuit power supply voltage VDD. The BGR power supply voltage Vs increases linearly from a value Vs1 to a value Vs2 between the time t0 and the time t5, and decreases linearly from the value Vs2 to the value Vs1 between the time t5 and the time t10.

The reference voltage Vr is smaller than the first predetermined value Ve during a period from the time t0 to before the time t2. When the BGR power supply voltage Vs reaches a third predetermined value Vsa which is higher than the value Vs1 at the time t2, the reference voltage Vr reaches the first predetermined value Ve. Between the time t0 and the time t2, the reference voltage Vr increases as the BGR power supply voltage Vs increases. During a period from the time t2 to the time t8, the BGR power supply voltage Vs is equal to or higher than the third predetermined value Vsa, and the reference voltage Vr is maintained constant at the first predetermined value Ve. That is, in the first embodiment, when the BGR power supply voltage Vs is equal to or higher than the third predetermined value Vsa, the reference voltage Vr is stabilized at the first predetermined value Ve. When the BGR power supply voltage Vs becomes lower than the third predetermined value Vsa after the time t8, the reference voltage Vr becomes lower than the first predetermined value Ve. Between the time t8 and the time t10, the reference voltage Vr decreases as the BGR power supply voltage Vs decreases. The third predetermined value Vsa is a value higher than the value Vs1 and lower than the value Vs2. The third predetermined value Vsa is, for example, the same value as the first predetermined value Ve. The third predetermined value Vsa may be a value different from the first predetermined value Ve.

As shown in FIG. 3, the first voltage V1 and the second voltage V2 are resistance-divided voltages of the reference voltage Vr, and thus change in the same manner as the reference voltage Vr from the time t0 to the time t10, although a magnitude of the voltage value is different. In the first embodiment, since the first voltage V1 and the second voltage V2 have the same value, the first voltage V1 and the second voltage V2 are maintained constant at a predetermined divided voltage value Ve1 between the time t2 and the time t8. The predetermined divided voltage value Ve1 is a value lower than the first predetermined value Ve.

The value Vs1 of the BGR power supply voltage Vs at the time t0 is greater than an absolute value of a threshold value of the control transistor 22. Therefore, when the BGR power supply voltage Vs is applied to the source terminal 22s of the control transistor 22 at the time t0, a gate-source voltage of the control transistor 22 becomes equal to or lower than the threshold value, and the control transistor 22 is in an ON state. When the control transistor 22 is in the ON state, a current flows from the power supply unit 10 to the first current path portion 26a and the second current path portion 26b, and the reference voltage Vr is generated on the reference voltage wiring 20a. When the BGR power supply voltage Vs is lower than the third predetermined value Vsa, the voltage Va and the voltage Vb input to the control circuit unit 21 do not have the same value, and the reference voltage Vr becomes lower than the first predetermined value Ve. In this case, in order to set the voltages Va and Vb to the same value, the control circuit unit 21 increases the current flowing through the control transistor 22 to raise the reference voltage Vr, thereby causing the drive voltage Vd to be zero or nearly zero. Therefore, as shown in FIG. 3, during a period from the time t0 until the time t2 when the BGR power supply voltage Vs is low and the reference voltage Vr cannot reach the first predetermined value Ve, the drive voltage Vd becomes nearly zero. When the reference voltage Vr is lower than the first predetermined value Ve, the current flowing through the control transistor 22 and the reference voltage Vr become larger as the BGR power supply voltage Vs increases.

In the example of FIGS. 2 and 3, when the BGR power supply voltage Vs becomes the third predetermined value Vsa at the time t2, the voltages Va and Vb have the same value, and the reference voltage Vr becomes the first predetermined value Ve. Here, when the BGR power supply voltage Vs becomes higher than the third predetermined value Vsa while the drive voltage Vd is zero or nearly zero, the voltages Va and Vb have different values, and the reference voltage Vr becomes higher than the first predetermined value Ve. In order to maintain a state in which the voltages Va and Vb have the same value, the control circuit unit 21 increases the drive voltage Vd when the BGR power supply voltage Vs becomes higher than the third predetermined value Vsa. Specifically, the control circuit unit 21 increases the drive voltage Vd so that a voltage difference between the source terminal 22s and the gate terminal 22g of the control transistor 22 becomes a constant value Vc. In other words, the control circuit unit 21 increases the drive voltage Vd so that a voltage difference between the BGR power supply voltage Vs and the drive voltage Vd becomes the constant value Vc. The value Vc is, for example, approximately the threshold value of the control transistor 22. The value Vc is, for example, approximately 0.7 V.

As shown in FIG. 3, when the BGR power supply voltage Vs becomes greater than the third predetermined value Vsa after the time t2, the drive voltage Vd rises sharply and then rises linearly until the time t5 together with the rise in the BGR power supply voltage Vs. The drive voltage Vd rises linearly as the BGR power supply voltage Vs increases after a time when a difference between the drive voltage Vd and the BGR power supply voltage Vs becomes a value Vc. In the example of FIG. 3, at a time t3a after the time t3, the difference between the drive voltage Vd and the BGR power supply voltage Vs becomes the value Vc. The value of the BGR power supply voltage Vs at the time t3a is a fourth predetermined value Vsb that is higher than the third predetermined value Vsa. The drive voltage Vd starts to drop together with the BGR power supply voltage Vs when the BGR power supply voltage Vs starts to drop after the time t5, drops sharply when the BGR power supply voltage Vs becomes lower than the fourth predetermined value Vsb after a time t6a has elapsed after the time t6, and then becomes zero or nearly zero. The time t3a is a time before the time t4. The time t6a is a time before the time t7.

The first determination circuit unit 31 compares the drive voltage Vd which varies as described above with the first voltage V1, and outputs the fourth voltage V4. Between the time t0 and the time t2, the drive voltage Vd is zero or nearly zero, and thus the drive voltage Vd is lower than the first voltage V1. In this case, the first determination circuit unit 31 sets the level of the fourth voltage V4 to be low (L). When the drive voltage Vd sharply rises and becomes higher than the first voltage V1 after the time t2, the first determination circuit unit 31 sets the level of the fourth voltage V4 to be high (H). In the example of FIG. 3, since the drive voltage Vd becomes equal to the first voltage V1 at the time t3, the first determination circuit unit 31 sets the level of the fourth voltage V4 to be high (H) after the time t3. Between the time t2 and the time t8, since the first voltage V1 is constant at the predetermined divided voltage value Ve1, during a period from the time t3 to the time t7 when the drive voltage Vd becomes higher than the predetermined divided voltage value Ve1, the level of the fourth voltage V4 is maintained in the high (H) state. When the drive voltage Vd becomes lower than the predetermined divided voltage value Ve1 after the time t7, the level of the fourth voltage V4 becomes low (L).

Here, the drive voltage Vd rises sharply from the value that is zero or nearly zero when the BGR power supply voltage Vs becomes higher than the third predetermined value Vsa and the reference voltage Vr becomes the first predetermined value Ve. Therefore, the BGR power supply voltage Vs when the drive voltage Vd becomes higher than the first voltage V1 is a value that can stabilize the reference voltage Vr at the first predetermined value Ve. Therefore, when the level of the fourth voltage V4 is high (H), the BGR power supply voltage Vs is the value that can stabilize the reference voltage Vr at the first predetermined value Ve, and the reference voltage Vr is at the first predetermined value Ve.

On the other hand, when the level of the fourth voltage V4 is low (L), except for short periods from the time t2 to the time t3 and from the time t7 to the time t8 when the drive voltage Vd changes sharply, the BGR power supply voltage Vs is lower than the third predetermined value Vsa, and the reference voltage Vr is lower than the first predetermined value Ve. Therefore, when the level of the fourth voltage V4 is low (L), it can be considered that the BGR power supply voltage Vs is a value that is not large enough to stabilize the reference voltage Vr at the first predetermined value Ve.

In this way, the first determination circuit unit 31 outputs the fourth voltage V4 as a signal indicating whether or not the reference voltage Vr is stable at the first predetermined value Ve, on the basis of the drive voltage Vd output from the control circuit unit 21. When the drive voltage Vd is higher than the first voltage V1, the first determination circuit unit 31 outputs the fourth voltage V4 of which the level is high as a signal indicating that the reference voltage Vr is stable at the first predetermined value Ve. The determination performed by the first determination circuit unit 31 is a determination method of the first embodiment for determining the reference voltage Vr generated by the bandgap reference circuit unit 20. The determination method includes determining whether or not the reference voltage Vr is stable at the first predetermined value Ve on the basis of the drive voltage Vd output from the control circuit unit 21. The determination method includes determining that the reference voltage Vr is stable at the first predetermined value Ve when the drive voltage Vd is higher than the first voltage V1 based on the reference voltage Vr.

The second determination circuit unit 32 compares the third voltage V3 which is a resistance-divided voltage of the circuit power supply voltage VDD with the second voltage V2 which is a resistance-divided voltage of the reference voltage Vr to determine whether or not the circuit power supply voltage VDD has dropped below the second predetermined value VDDa. Here, when the reference voltage Vr is always at the first predetermined value Ve, it is possible to determine whether or not the circuit power supply voltage VDD has become lower than the second predetermined value VDDa on the basis of a determination result of only the second determination circuit unit 32. However, as described above, when the BGR power supply voltage Vs is lower than the third predetermined value Vsa, the reference voltage Vr becomes lower than the first predetermined value Ve and becomes unstable. Therefore, when the BGR power supply voltage Vs is lower than the third predetermined value Vsa, the second determination circuit unit 32 may produce an erroneous output.

In the example of FIG. 3, between the time t0 and the time t1, between the time t4 and the time t6, and between the time t9 and the time t10, the third voltage V3 is higher than the second voltage V2, and the level of the fifth voltage V5 is high (H). During a period from the time t2 to the time t8 when the second voltage V2 is stable at the constant predetermined divided voltage value Ve1, at the time t4 and the time t6 when the value of the third voltage V3 becomes the same value as the value of the second voltage V2, that is, the predetermined divided voltage value Ve1, as shown in FIG. 2, the circuit power supply voltage VDD becomes the second predetermined value VDDa. Therefore, during a period from the time t4 to the time t6, the circuit power supply voltage VDD becomes equal to or higher than the second predetermined value VDDa. Therefore, the second determination circuit unit 32 is operating normally when the level of the fifth voltage V5 is high (H) between the time t4 and the time t6. On the other hand, between the time t0 and the time t1 and between the time t9 and the time t10, the circuit power supply voltage VDD is lower than the second predetermined value VDDa. Therefore, when the second determination circuit unit 32 is performing a normal determination operation, the level of the fifth voltage V5 is low (L) from the time t0 to the time t1 and from the time t9 to the time t10. However, between the time t0 and the time t1 and between the time t9 and the time t10, since the reference voltage Vr is unstable and lower than the first predetermined value Ve, even though the circuit power supply voltage VDD is lower than the second predetermined value VDDa, the third voltage V3 is higher than the second voltage V2, and the level of the fifth voltage V5 is high (H). That is, the second determination circuit unit 32 produces an erroneous output between the time t0 and the time t1 and between the time t9 and the time t10.

In the first embodiment, as described above, the first determination circuit unit 31 and the third determination circuit unit 33 are provided to curb the output voltage Vt that is finally output being erroneously output, even when the second determination circuit unit 32 produces an erroneous output. As described above, the fourth voltage V4 output from the first determination circuit unit 31 is a signal indicating whether or not the reference voltage Vr is stable at the first predetermined value Ve. Therefore, in the determination by the second determination circuit unit 32 when the level of the fourth voltage V4 is high (H), since the reference voltage Vr is stable at the first predetermined value Ve, the occurrence of the erroneous output as described above is curbed.

Here, the third determination circuit unit 33 sets the level of the output voltage Vt to be high (H) only when both the level of the fourth voltage V4 input from the first determination circuit unit 31 and the level of the fifth voltage V5 input from the second determination circuit unit 32 are high (H). Therefore, in the example of FIG. 3, the level of the output voltage Vt is high (H) only from the time t4 to the time t6 when the level of the fifth voltage V5 is high (H) during a period from the time t3 to the time t7 when the level of the fourth voltage V4 is high (H). In this way, since the first determination circuit unit 31 and the third determination circuit unit 33 are provided, even when the level of the fifth voltage V5 is high (H) when the reference voltage Vr is unstable, the level of the output voltage Vt does not become high (H). Therefore, the erroneous output of the output voltage Vt is curbed.

A voltage range in which the first determination circuit unit 31 operates includes a voltage range in which the second determination circuit unit 32 operates. The voltage range in which the first determination circuit unit 31 operates is the same as or wider than the voltage range in which the second determination circuit unit 32 operates. Thus, in a voltage range in which the first determination circuit unit 31 does not operate, the second determination circuit unit 32 does not operate. Therefore, even when the second determination circuit unit 32 produces an erroneous output, the first determination circuit unit 31 does not fail to operate, and the erroneous output of the output voltage Vt can be suitably curbed.

A value of the BGR power supply voltage Vs at a threshold value of the operation of the second determination circuit unit 32 is greater than a value of the BGR power supply voltage Vs when the reference voltage Vr collapses. The threshold value of the operation of the second determination circuit unit 32 is a value at which the level of the fifth voltage V5 output when the second determination circuit unit 32 operates normally switches between the high level and the low level. The value of the BGR power supply voltage Vs when the reference voltage Vr collapses is a value at which the BGR power supply voltage Vs is lower than the voltage values shown in FIGS. 2 and 3, and at which the reference voltage Vr cannot be generated. When the value of the BGR power supply voltage Vs at the threshold value of the operation of the second determination circuit unit 32 is equal to or lower than the value of the BGR power supply voltage Vs when the reference voltage Vr collapses, in the entire voltage range in which the reference voltage Vr is generated, the level of the fifth voltage V5 becomes high (H), and the second determination circuit unit 32 does not operate normally.

According to the first embodiment, the semiconductor circuit 100 includes the bandgap reference circuit unit 20 that generates the reference voltage Vr, and the detection circuit unit 30. The bandgap reference circuit unit 20 includes the control transistor 22 disposed between the wiring 11 to which the BGR power supply voltage Vs (the first power supply voltage) is applied and the reference voltage wiring 20a to which the reference voltage Vr is applied, and the control circuit unit 21 that applies the drive voltage Vd to the control transistor 22 so that the reference voltage Vr becomes the first predetermined value Ve. The control transistor 22 has the source terminal 22s (the first terminal) connected to the wiring to which the BGR power supply voltage Vs is applied, the drain terminal 22d (the second terminal) connected to the reference voltage wiring 20a, and the gate terminal 22g (the drive terminal) to which the drive voltage Vd is applied, and is in the ON state when the voltage of the gate terminal 22g relative to the voltage of the source terminal 22s is a negative value and becomes equal to or lower than a threshold value. The detection circuit unit 30 includes the first determination circuit unit 31 that outputs a signal indicating whether or not the reference voltage Vr is stable at the first predetermined value Ve, on the basis of the drive voltage Vd output from the control circuit unit 21. In other words, the determination method of the first embodiment includes determining whether or not the reference voltage Vr is stable at the first predetermined value Ve on the basis of the drive voltage Vd output from the control circuit unit 21.

When the BGR power supply voltage Vs is lower than a value that can stabilize the reference voltage Vr at the first predetermined value Ve, in order to control the control transistor 22 so that the reference voltage Vr becomes the first predetermined value Ve, the control circuit unit 21 attempts to raise the reference voltage Vr by putting the control transistor 22 into a state in which a large current can flow. Since the control transistor 22 is in the ON state when the voltage of the gate terminal 22g relative to the voltage of the source terminal 22s is a negative value and becomes equal to or lower than a threshold value, the control circuit unit 21 keeps the drive voltage Vd at zero or nearly zero until the BGR power supply voltage Vs reaches a value that can stabilize the reference voltage Vr at the first predetermined value Ve. On the other hand, when the BGR power supply voltage Vs becomes greater than the value that sets the reference voltage Vr to the first predetermined value Ve, the control circuit unit 21 increases the drive voltage Vd to curb the current flowing through the control transistor 22 becoming too large and the reference voltage Vr becoming higher than the first predetermined value Ve. Therefore, when the BGR power supply voltage Vs is equal to or higher than the value that can stabilize the reference voltage Vr at the first predetermined value Ve, the drive voltage Vd rises from a state of zero or nearly zero. Therefore, by determining whether or not the drive voltage Vd has risen from a zero or nearly zero state using the first determination circuit unit 31, it is possible to determine whether or not the reference voltage Vr is stable at the first predetermined value Ve. The drive voltage Vd is a value that is automatically adjusted by the control circuit unit 21 according to a change in the BGR power supply voltage Vs. Therefore, even if a designer of the semiconductor circuit 100 does not set a threshold value in advance, it is possible to determine whether or not the reference voltage Vr is stable by performing a determination with the first determination circuit unit 31 on the basis of the drive voltage Vd. Therefore, the region in which the reference voltage Vr is stable can be easily determined.

According to the first embodiment, the drive voltage Vd and the first voltage V1 based on the reference voltage Vr are input to the first determination circuit unit 31. When the drive voltage Vd is higher than the first voltage V1, the first determination circuit unit 31 outputs a signal indicating that the reference voltage Vr is stable at the first predetermined value Ve, that is, the fourth voltage V4 of which the level is high. In other words, the determination method of the first embodiment includes determining that the reference voltage Vr is stable at the first predetermined value Ve when the drive voltage Vd is higher than the first voltage V1 based on the reference voltage Vr. When the reference voltage Vr is stable, it is maintained at the first predetermined value Ve, and thus when the reference voltage Vr is stable, the first voltage V1 based on the reference voltage Vr is also maintained at the predetermined divided voltage value Ve1. Therefore, when the drive voltage Vd starts to rise, the first voltage V1 is at the predetermined divided voltage value Ve1. Therefore, the first determination circuit unit 31 can easily determine that the reference voltage Vr is stable by determining that the rising drive voltage Vd has become higher than the predetermined divided voltage value Ve1.

According to the first embodiment, the first voltage V1 is a resistance-divided voltage of the reference voltage Vr. Therefore, the first voltage V1 is lower than the reference voltage Vr. Thus, the predetermined divided voltage value Ve1 at which the first voltage V1 is stable is also lower than the first predetermined value Ve at which the reference voltage Vr is stable. Therefore, when the reference voltage Vr reaches the first predetermined value Ve and the drive voltage Vd rises, the value of the BGR power supply voltage Vs when the drive voltage Vd becomes the same value as the predetermined divided voltage value Ve1 can be reduced. Thus, the value of the BGR power supply voltage Vs when the drive voltage Vd becomes higher than the predetermined divided voltage value Ve1 can be reduced within a range in which the reference voltage Vr can be stabilized. Therefore, the range of the BGR power supply voltage Vs in which the first determination circuit unit 31 can determine that the reference voltage Vr is stable can be suitably widened. The value at which the first voltage V1 is stable, that is, the predetermined divided voltage value Ve1, is preferably set, for example, to be higher than 0 V and also within a range equal to or lower than a minimum value of the drive voltage Vd among values of the drive voltage Vd at which a difference with the BGR power supply voltage Vs is the value Vc. The value of the drive voltage Vd at which the difference with the BGR power supply voltage Vs is the value Vc is a value of the drive voltage Vd from the time t3a to the time t6a. The minimum value of the drive voltage Vd among the values of the drive voltage Vd at which the difference with the BGR power supply voltage Vs is the value Vc is a value of the drive voltage Vd at the times t3a and t6a. By setting the predetermined divided voltage value Ve1 to be higher than 0 V and equal to or lower than the minimum value of the drive voltage Vd, the value of the drive voltage Vd can be made equal to or higher than the value of the first voltage V1 throughout the entire range in which the difference between the drive voltage Vd and the BGR power supply voltage Vs changes by the value Vc. The range in which the difference between the drive voltage Vd and the BGR power supply voltage Vs changes by the value Vc is a region in which the reference voltage Vr is stable. Therefore, by setting the predetermined divided voltage value Ve1 at which the first voltage V1 is stable as described above, the range of the BGR power supply voltage Vs at which the first determination circuit unit 31 can determine that the reference voltage Vr is stable, that is, the range at which the fourth voltage V4 is high (H), can be more suitably widened.

In the first embodiment, the predetermined divided voltage value Ve1 at which the first voltage V1 is stable is equal to or lower than a value obtained by subtracting the value Vc from the first predetermined value Ve. Thus, during a period from the time t2 to the time t3 when the drive voltage Vd rises sharply, and during a period from the time t7 to the time t8 when the drive voltage Vd drops sharply, the drive voltage Vd can be made to have the same value as the predetermined divided voltage value Ve1. Therefore, the range of the BGR power supply voltage Vs in which the first determination circuit unit 31 can determine that the reference voltage Vr is stable can be more suitably widened. The predetermined divided voltage value Ve1 shown in FIG. 3 is, for example, the same as the value obtained by subtracting the value Vc from the first predetermined value Ve. When the BGR power supply voltage Vs becomes the fourth predetermined value Vsb, the difference between the BGR power supply voltage Vs and the drive voltage Vd may become the value Vc, and the drive voltage Vd may become equal to the predetermined divided voltage value Ve1.

According to the first embodiment, the detection circuit unit 30 includes the second determination circuit unit 32 and the third determination circuit unit 33, and is capable of detecting that the circuit power supply voltage VDD has become lower than the second predetermined value VDDa on the basis of the reference voltage Vr. The second voltage V2 based on the reference voltage Vr and the third voltage V3 based on the circuit power supply voltage VDD are input to the second determination circuit unit 32. The signal output from the first determination circuit unit 31, that is, the fourth voltage V4, and the signal output from the second determination circuit unit 32, that is, the fifth voltage V5 are input to the third determination circuit unit 33. When a predetermined condition is satisfied, the third determination circuit unit 33 outputs a signal indicating that the circuit power supply voltage VDD is equal to or higher than the second predetermined value VDDa, that is, the output voltage Vt of which the level is high. When the fourth voltage V4 output from the first determination circuit unit 31 is a signal indicating that the drive voltage Vd is equal to or lower than the first voltage V1, the third determination circuit unit 33 outputs a signal indicating that the circuit power supply voltage VDD is lower than the second predetermined value VDDa, that is, the output voltage Vt of which the level is low. When the signal output from the second determination circuit unit 32 is a signal indicating that the third voltage V3 is equal to or lower than the second voltage V2, the third determination circuit unit 33 outputs a signal indicating that the circuit power supply voltage VDD is lower than the second predetermined value VDDa, that is, the output voltage Vt of which the level is low. The predetermined condition is satisfied when the fourth voltage V4 output from the first determination circuit unit 31 is a signal indicating that the drive voltage Vd is higher than the first voltage V1 and the fifth voltage V5 output from the second determination circuit unit 32 is a signal indicating that the third voltage V3 is higher than the second voltage V2. Therefore, even though the second determination circuit unit 32 produces an erroneous output when the reference voltage Vr is unstable, the output voltage Vt does not produce an erroneous output unless the first determination circuit unit 31 determines that the drive voltage Vd is higher than the first voltage V1. Therefore, the detection circuit unit 30 can monitor the circuit power supply voltage VDD with high accuracy on the basis of the reference voltage Vr.

According to the first embodiment, the second voltage V2 is a resistance-divided voltage of the reference voltage Vr. The third voltage V3 is a resistance-divided voltage of the circuit power supply voltage VDD. Therefore, the magnitudes of the second voltage V2 and the third voltage V3 compared in the second determination circuit unit 32 can be adjusted by adjusting the resistance values of the resistor elements 34a to 34d, regardless of the magnitudes of the reference voltage Vr and the circuit power supply voltage VDD. Thus, the value of the circuit power supply voltage VDD when the third voltage V3 becomes equal to the second voltage V2, that is, the second predetermined value VDDa, can be set regardless of the magnitudes of the reference voltage Vr and the circuit power supply voltage VDD.

According to the first embodiment, the BGR power supply voltage Vs is a voltage generated on the basis of the circuit power supply voltage VDD. Therefore, the BGR power supply voltage Vs can be generated without providing a separate external power supply. The effect of being able to easily determine the region in which the reference voltage Vr is stable on the basis of the drive voltage Vd can be particularly usefully obtained when the BGR power supply voltage Vs is a voltage generated on the basis of the circuit power supply voltage VDD. The details will be described below.

For example, in the past, a monitoring circuit unit that monitors the circuit power supply voltage VDD was provided instead of the first determination circuit unit 31, and when the circuit power supply voltage VDD was equal to or higher than the second predetermined value VDDa, by setting a level of an input from the monitoring circuit unit to the third determination circuit unit 33 to be high, it is possible to curb an erroneous output occurring when the reference voltage Vr becomes low and unstable. However, with this method, it was necessary to identify in advance what the value of the circuit power supply voltage VDD will cause the reference voltage Vr to become unstable, and to set a threshold value of the monitoring circuit unit on the basis of the identified value. Furthermore, when the BGR power supply voltage Vs is a voltage generated on the basis of the circuit power supply voltage VDD, variations in characteristics of the circuit that generates the BGR power supply voltage Vs, that is, the power supply unit 10, cause variations in the value of the BGR power supply voltage Vs relative to the circuit power supply voltage VDD. Therefore, the threshold value set in the monitoring circuit unit that monitors the circuit power supply voltage VDD needs to be a threshold value that takes into account these variations, which poses a problem in that the voltage range in which it can be determined that the reference voltage Vr is stable becomes unnecessarily narrow.

Regarding this problem, according to the first embodiment, as described above, since it is possible to easily determine whether or not the reference voltage Vr is stabilized by monitoring the drive voltage Vd with the first determination circuit unit 31, there is no need to set the range of the circuit power supply voltage VDD in which the reference voltage Vr becomes unstable, as in the above-described monitoring circuit unit. Furthermore, even when the BGR power supply voltage Vs is generated on the basis of the circuit power supply voltage VDD, the state of the reference voltage Vr can be monitored using the drive voltage Vd, and thus even when there are variations in the BGR power supply voltage Vs with respect to the circuit power supply voltage VDD, it can be accurately detected that the reference voltage Vr has stabilized. Therefore, the voltage range in which it can be determined that the reference voltage Vr is stable can be easily adjusted to a range in which the reference voltage Vr is actually stable at the first predetermined value Ve. Therefore, the voltage range in which it can be determined that the reference voltage Vr is stable using the first determination circuit unit 31 can be prevented from becoming unnecessarily narrow. As described above, the effect of being able to easily determine the region in which the reference voltage Vr is stable on the basis of the drive voltage Vd can be particularly usefully obtained when the BGR power supply voltage Vs is a voltage generated on the basis of the circuit power supply voltage VDD.

According to the first embodiment, the control transistor 22 is a P-channel type field-effect transistor. Therefore, unlike a case in which the control transistor 22 is a bipolar transistor, no current flows from the source terminal 22s which is the first terminal to the gate terminal 22g which is the drive terminal. Therefore, power consumption can be reduced more easily than the case in which the control transistor 22 is a bipolar transistor. Furthermore, since no current flows from the gate terminal 22g to the control circuit unit 21 and the first determination circuit unit 31, the operation of each of the circuit units can be more easily stabilized. Furthermore, since there is no need to provide a resistor element for converting a current into a voltage, the number of components in the semiconductor circuit 100 can be reduced.

### (Second Embodiment)

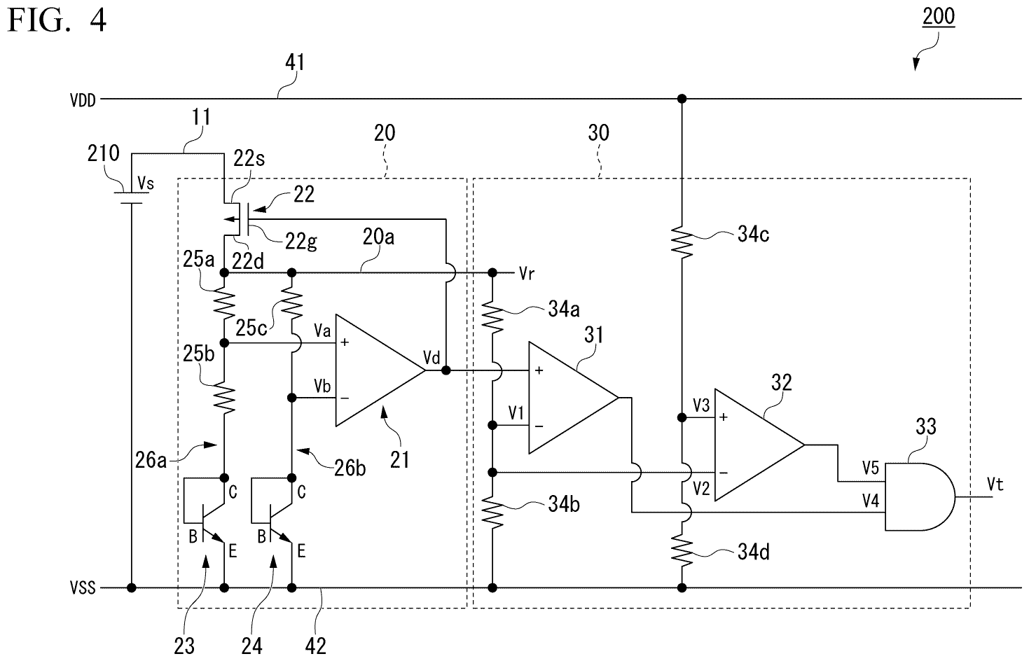

FIG. 4 is a circuit diagram showing a semiconductor circuit 200 according to a second embodiment. In the following description, the same components as those in the above-described embodiment are denoted by the same reference numerals, and the description thereof may be omitted. A power supply unit 210 of the semiconductor circuit 200 shown in FIG. 4 is an external power supply. The power supply unit 210 applies the BGR power supply voltage Vs to the control transistor 22. In the second embodiment, the BGR power supply voltage Vs output from the power supply unit 210 is a voltage that is generated independently of the circuit power supply voltage VDD. The power supply unit 210 is connected to the ground 42. In the second embodiment, since the power supply unit 210 is an external power supply, it is possible to reduce the variations in the BGR power supply voltage Vs with respect to the circuit power supply voltage VDD, compared to a case in which the power supply unit 210 is an internal power supply based on the circuit power supply voltage VDD. The other configurations of the semiconductor circuit 200 are similar to the other configurations of the semiconductor circuit 100 in the first embodiment.

### (Third Embodiment)

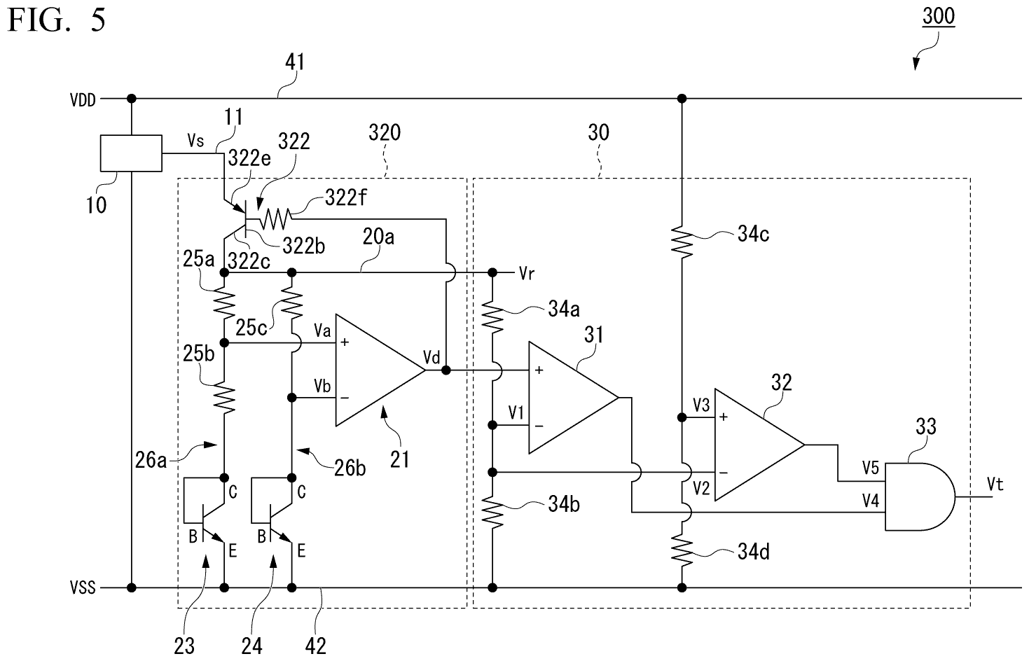

FIG. 5 is a circuit diagram showing a semiconductor circuit 300 according to a third embodiment. In the following description, configurations similar to those in the above-described embodiments may be denoted by the same reference numerals, and the description thereof may be omitted. As shown in FIG. 5, a control transistor 322 in a bandgap reference circuit unit 320 of the semiconductor circuit 300 is a PNP type bipolar transistor. The control transistor 322 has an emitter terminal 322e, a collector terminal 322c, and a base terminal 322b. The emitter terminal 322e is connected to the wiring 11. The collector terminal 322c is connected to the reference voltage wiring 20a. A drive voltage Vd is applied to the base terminal 322b. A resistor element 322f for converting a current into a voltage is connected to the base terminal 322b. In the third embodiment, the emitter terminal 322e corresponds to the “first terminal,” the collector terminal 322c corresponds to the “second terminal,” and the base terminal 322b corresponds to the “drive terminal. ” Even when the control transistor 322 is a PNP type bipolar transistor, the semiconductor circuit 300 operates in the same manner as the semiconductor circuit 100 in the above-described first embodiment. The other configurations of the semiconductor circuit 300 are similar to the other configurations of the semiconductor circuit 100 in the first embodiment.

According to the third embodiment, the control transistor 322 is a PNP type bipolar transistor. Therefore, the control transistor 322 can be made less expensive than a case in which a P-channel type field-effect transistor is used as the control transistor 322.

According to at least one of the embodiments described above, the semiconductor circuit of the embodiment has the bandgap reference circuit unit that generates the reference voltage, and the detection circuit unit. The bandgap reference circuit unit has the control transistor disposed between the wiring to which the first power supply voltage is applied and the reference voltage wiring to which the reference voltage is applied, and the control circuit unit that applies the drive voltage to the control transistor so that the reference voltage becomes the first predetermined value. The control transistor has the first terminal connected to the wiring to which the first power supply voltage is applied, the second terminal connected to the reference voltage wiring, and the drive terminal to which the drive voltage is applied. The control transistor is in the ON state when the voltage of the drive terminal relative to the voltage of the first terminal is a negative value and is equal to or lower than a threshold value. The detection circuit unit includes the first determination circuit unit that outputs a signal indicating whether or not the reference voltage is stable at the first predetermined value on the basis of the drive voltage output from the control circuit unit. Thus, the region in which the reference voltage is stable can be easily determined on the basis of the drive voltage output from the control circuit unit.

The first determination circuit unit may have any configuration as long as it can determine whether or not the reference voltage is stable at the first predetermined value on the basis of the drive voltage output from the control circuit unit. The first determination circuit unit may have a threshold value stored therein in advance, and may determine whether or not the reference voltage is stable by comparing the threshold value with the drive voltage. In the determination method of the embodiment, whether or not the reference voltage is stable may be determined in any manner. In the determination method, a processor to which the drive voltage output from the control circuit unit is input may determine whether or not the reference voltage is stable on the basis of the drive voltage. In this case, the processor may determine whether or not the reference voltage is stable by executing a program stored in the storage unit.

The first power supply voltage may be any voltage. The second power supply voltage may be any voltage. The first voltage may be any voltage as long as it is a voltage based on the reference voltage. The first voltage may be the same value as the reference voltage. The second voltage may be any voltage as long as it is a voltage based on the reference voltage. The second voltage may be the same value as the reference voltage. The first voltage and the second voltage may be different from each other. The third voltage may be any voltage as long as it is a voltage based on the second power supply voltage (the circuit power supply voltage). The third voltage may be the same value as the second power supply voltage.

The second determination circuit unit and the third determination circuit unit may have any circuit configuration as long as they have their respective determination functions. The second determination circuit unit and the third determination circuit unit do not necessarily have to be provided. The detection circuit unit may be a circuit that performs any kind of detection as long as it has the first determination circuit unit. The control circuit unit may have any configuration as long as it can apply a drive voltage to the control transistor so that the reference voltage becomes the first predetermined value. The control transistor may be any type of transistor as long as it is in an ON state when the voltage of the drive terminal relative to the voltage of the first terminal is a negative value and is equal to or less than a threshold value. The configuration of the bandgap reference circuit unit that generates the reference voltage is not limited to the above-described embodiment. As for the configuration of the bandgap reference circuit, the configuration of any known bandgap reference circuit can be adopted. The use of the semiconductor circuit is not particularly limited.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor circuit comprising:
a bandgap reference circuit unit configured to generate a reference voltage; and
a detection circuit unit,
wherein the bandgap reference circuit unit includes a control transistor disposed between a wiring to which a first power supply voltage is applied and a reference voltage wiring to which the reference voltage is applied, and a control circuit unit configured to apply a drive voltage to the control transistor so that the reference voltage becomes a first predetermined value,
the control transistor includes a first terminal connected to a wiring to which the first power supply voltage is applied, a second terminal connected to the reference voltage wiring, and a drive terminal to which the drive voltage is applied, and is in an ON state when a voltage of the drive terminal relative to a voltage of the first terminal is a negative value and is equal to or lower than a threshold value, and
the detection circuit unit has a first determination circuit unit that outputs a signal indicating whether or not the reference voltage is stable at the first predetermined value on the basis of the drive voltage output from the control circuit unit.

2. The semiconductor circuit according to claim 1, wherein
the drive voltage and a first voltage based on the reference voltage are input to the first determination circuit unit, and
the first determination circuit unit outputs a signal indicating that the reference voltage is stable at the first predetermined value when the drive voltage is higher than the first voltage.

3. The semiconductor circuit according to claim 2, wherein
the first voltage is a resistance-divided voltage of the reference voltage.

4. The semiconductor circuit according to claim 2, wherein
the detection circuit unit includes a second determination circuit unit and a third determination circuit unit, and is configured to detect that the second power supply voltage has become lower than a second predetermined value on the basis of the reference voltage,
a second voltage based on the reference voltage and a third voltage based on the second power supply voltage are input to the second determination circuit unit,
a signal output from the first determination circuit unit and a signal output from the second determination circuit unit are input to the third determination circuit unit,
the third determination circuit unit outputs a signal indicating that the second power supply voltage is equal to or higher than the second predetermined value when a predetermined condition is satisfied, outputs a signal indicating that the second power supply voltage is lower than the second predetermined value when the signal output from the first determination circuit unit is a signal indicating that the drive voltage is equal to or lower than the first voltage, and also outputs a signal indicating that the second power supply voltage is lower than the second predetermined value when the signal output from the second determination circuit unit is a signal indicating that the third voltage is equal to or lower than the second voltage, and
the predetermined condition is satisfied when the signal output from the first determination circuit unit is a signal indicating that the drive voltage is higher than the first voltage, and when the signal output from the second determination circuit unit is a signal indicating that the third voltage is higher than the second voltage.

5. The semiconductor circuit according to claim 4, wherein
the second voltage is a resistance-divided voltage of the reference voltage, and
the third voltage is a resistance-divided voltage of the second power supply voltage.

6. The semiconductor circuit according to claim 4, wherein
the first power supply voltage is a voltage generated on the basis of the second power supply voltage.

7. The semiconductor circuit according to claim 1, wherein
the control transistor is a P-channel type field-effect transistor.

8. The semiconductor circuit according to claim 1, wherein
the control transistor is a PNP type bipolar transistor.

9. A determination method for determining a reference voltage generated by a bandgap reference circuit unit,
wherein the bandgap reference circuit unit includes a control transistor disposed between a wiring to which a first power supply voltage is applied and a reference voltage wiring to which the reference voltage is applied, and a control circuit unit configured to apply a drive voltage to the control transistor so that the reference voltage becomes a first predetermined value,
the control transistor includes a first terminal connected to a wiring to which the first power supply voltage is applied, a second terminal connected to the reference voltage wiring, and a drive terminal to which the drive voltage is applied, and is in an ON state when a voltage of the drive terminal relative to a voltage of the first terminal is a negative value and is equal to or lower than a threshold value, and
the determination method includes determining whether or not the reference voltage is stable at the first predetermined value based on the drive voltage output from the control circuit unit.

10. The determination method according to claim 9, comprising determining that the reference voltage is stable at the first predetermined value when the drive voltage is higher than a first voltage based on the reference voltage.
